(19) United States
(12) Patent Application Publication
(10) Pub. No.: US 2012/0192125 A1
(43) Pub. Date: Jul. 26, 2012

(54) Correcting and Optimizing Contours for Optical Proximity Correction Modeling

(75) Inventors: Daniel S. Fischer, Wappingers Falls, NY (US); Dongbing Shao, Wappingers Falls, NY (US)

(73) Assignee: INTERNATIONAL BUSINESS MACHINES CORPORATION, Armonk, NY (US)

(21) Appl. No.: 13/009,962

(22) Filed: Jan. 20, 2011

(51) Int. Cl. G06F 17/50

(52) U.S. Cl. 716/55

(57) ABSTRACT

A contour biasing method can include receiving contour input files, processing the contour input files, receiving contour measurements, receiving raw contour data, processing the raw contour data and outputting processed contour data based on the contour input files.

### BACKGROUND

The present invention relates to optical proximity correction (OPC) modeling, and more specifically, to systems and methods for correcting and optimizing OPC modeling accuracy. OPC is a widely used resolution enhancement technique for control of critical dimension (CD) data. Due to optical interference effects a photomask design does not print the same on a wafer if it's isolated or if it's next to some patterns. OPC models these proximity effects and inverse-calculates the right mask size so that the photomask can be printed uniformly from iso to dense patterns. With OPC, photomask shapes are deliberately distorted to compensate for differing amounts of pattern information diffracted at various pitches. The goal is to compensate for errors introduced by lithography between the design data and the actual device layout. The traditional OPC modeling methodology requires a large amount of CD data from scanning electron microscopy (SEM) tools to feed to OPC modeling software to calculate edge placement error (EPE) data. Currently, an emerging modeling technique called contour modeling significantly reduces the metrology demand on SEM data, while better characterizing the lithography process. However, the contour data from the SEM tools have large errors if directly used by contour modeling software due to SEM tool errors and contour-physical bias. With regard to SEM tool errors, the contour from SEM tools may have errors such as, magnification, perpendicularity, rotation and shift in x and/or y due to wafer to design coordinate translation. For example, SEM tool magnification arises because of the calibration procedure of SEM tool. For CD data, the scan range, and thus the error caused by magnification, is relatively small. However, contour data usually has a scan range of a few microns and it requires both axes to be calibrated accurately. As such, the errors of contour close to the boundary of scan area are significant to affect OPC modeling. Although the SEM tool can be calibrated, to avoid skewed contour errors, a user typically checks and corrects the magnification errors before modeling. With regard to contour-physical bias, there is typically a bias between SEM data and physical data due to resist shrinkage and/or electron emission, which are both function of resist geometry (e.g. side-wall angles and curvature). The SEM CD data can easily be corrected by applying a bias based on feature type (e.g., 1D vs 2D) and tone (e.g., line vs space) with data from atomic force microscopy (AFM) work. However there is no existing method to apply a bias on SEM contours.

### SUMMARY

Exemplary embodiments include a contour biasing method, including receiving contour input files, processing the contour input files, receiving contour measurements, receiving raw contour data, processing the raw contour data and outputting processed contour data based on the contour input files.

Additional embodiments include a computer program product including a non-transitory computer readable medium having instructions for causing a computer to implement a contour biasing method, including receiving contour input files, processing the contour input files, receiving contour measurements, receiving raw contour data, processing the raw contour data and outputting processed contour data based on the contour input files.

Further embodiments include a contour biasing system, including a processor configured to receive contour input files for a design based metrology system, process the contour input files, receive contour measurements, receive raw contour data from a scanning electron microscopy system, process the raw contour data and output processed contour data based on the contour input files.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates an example of a curve fit to several points of a photomask contour;

FIG. 2 illustrates a flowchart of a method for contour biasing in accordance with exemplary embodiments;

FIG. 3 illustrates an exemplary system in which contour biasing methods can be implemented;

FIG. 4 illustrates an example in accordance with exemplary embodiments; and

FIG. 5 illustrates correction for 2D example contours.

### DETAILED DESCRIPTION

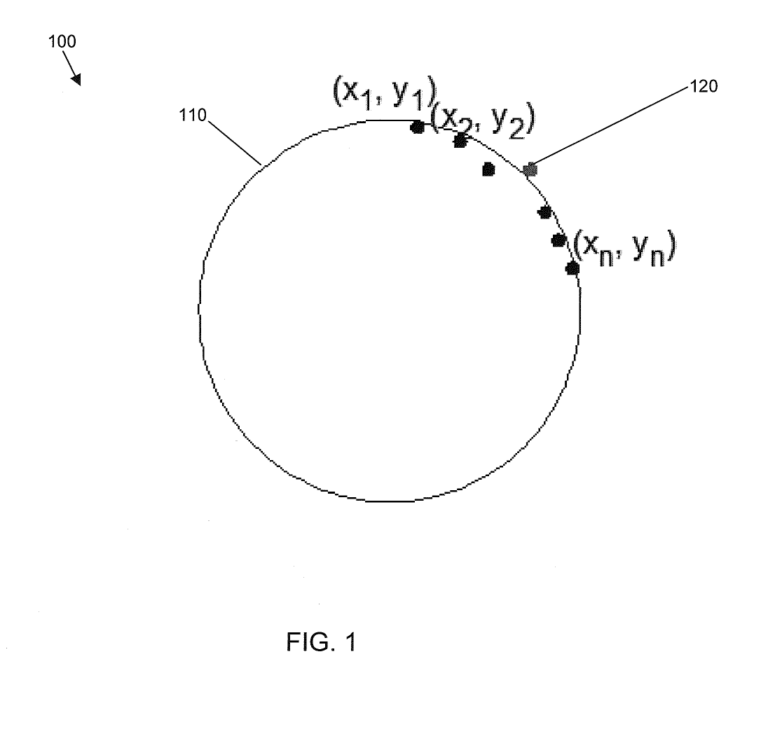

In exemplary embodiments, the systems and methods described herein apply a variable bias to SEM contours to correct errors as described herein, as well as fixing contour SEM errors. As such, SEM contour correction/optimization can be automatically implemented in OPC modeling software for contour modeling. In contour biasing as described herein, SEM contours include many points having corresponding coordinates (e.g., x and y coordinates). For a given number of points in a plane, for example, a curve such as a circle (or any suitable shape) can be calculated to fit the points with least mean square error. FIG. 1 illustrates an example 100 of a curve fit to several points having coordinates (X1, Y1), (X2, Y2) . . . (Xn, Yn) of a SEM contour 110. The points can then be shifted with a predetermined offset. In exemplary embodiments, the coordinates of each point on the contour (i.e., an SEM contour) can be read and processed and an appropriate curve can be fit to the points. The systems and methods described there can then correct errors and optimize the SEM contours. For SEM tool errors, the coordinates of each point on the measured contours can be used to re-calibrate the magnification, perpendicularity, rotation and shift. The coordinates can then be recalculated, snapped to the graphic database system (GDS) gird and saved. The contour-physical biasing can be corrected in two approaches or steps. The contour shape needs to be divided into 1D and 2D contours. Biasing for 1D contour can simply be offsetting the coordinates to size-up or down the contour shape by the 1D SEM-physical bias. For 2D contour, for each point on the contour path, the systems and methods described herein use the neighboring points to do a least square fit with a curve such as a circle. The new location is then the fitted location plus a bias offset, which depends on the tone as well as the curvature. The adjacent n points on each side (2n+1 points total) are fit with the contour 100 to find the local curvature, as illustrated in FIG. 1. The point 120, for example, is a point to be corrected. The choice of n for the number of points to use in the curve fitting is selected taking several factors into account. For example, if n is too small, then the curve fitting result picks up random noise. If the choice of n is too large them, the curve fitting can miss the local curvature and run time can largely increase. By implementing a fitted location instead of original location, the systems and methods described herein also smooth the curve, as the fitted location is an average based on the neighboring points.

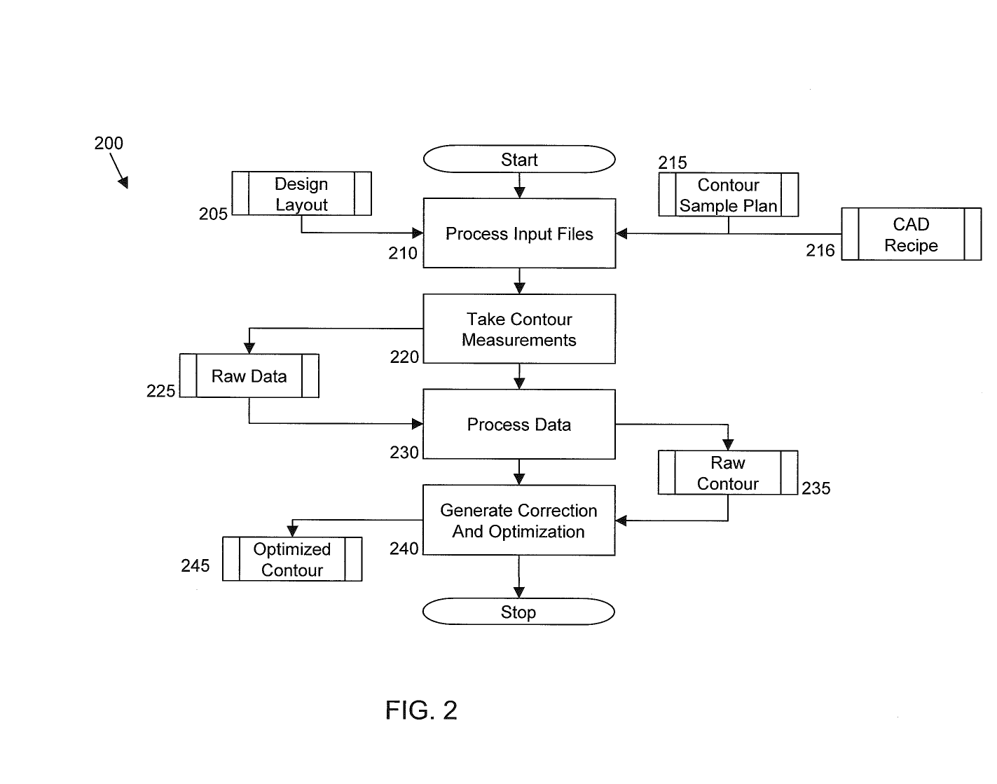

In exemplary embodiments, the systems and methods described herein apply a bias to raw contour data to modify and optimize actual contours on devices. FIG. 2 illustrates a flowchart of a method 200 for contour biasing in accordance with exemplary embodiments. In semiconductor fabrication, routine measurements are made of critical devices or features throughout the manufacturing process flow. Critical Dimension Scanning Electron Microscopy (CD-SEM) is typically implemented to measure these features on the wafer since it is fast and relatively non-destructive. Measurement of such structures requires the ability of the CD-SEM to locate the general area of the structure(s) of interest, and also to recognize the structures on the wafer. As such, the devices are located based on the design layout. As described herein, at block 210 a Design Based Metrology (DBM) system is implemented to receive and process design layout files 205 as well as a contour sample plan 215. The DBM system can also receive and process a computer aided design (CAD) recipe file 216, which can provide processing directions. In exemplary embodiments, the contour sample plan 215 provides a contour (such as the contour 120 in FIG. 1). As described herein, the fabricated wafer can differ considerably from the design layout due largely to the structural differences between the design layout and an actual fabricated device.

Referring still to FIG. 2, at block 220, a user can take contour measurements of the photomask to obtain raw data 225. In exemplary embodiments, the measurements can be taken with SEM tools. At block 230, the DBM system processes the raw data 225 to generate raw contour data 235, which can be stored in a suitable file such as a graphic design system file (.gds file). At block 240, the systems and methods described herein can generate correction and optimization to the generated contour. As discussed herein, correction and optimization can include SEM error data (if available), registration and magnification, and SEM-physical bias data, which can be a function of curvature of the curve. The output is then optimized contour data 245, which can be saved in a .gds file. The method 200 can therefore be implemented for optimizing and improving SEM contour quality in order to minimize artificial metrology error within model based OPC flow. The correction and optimization at block 240 can include but is not limited to: 1) contour vector shifting based on pattern dependant SEM metrology error; 2) global scaling to correct for SEM magnification; and 3) rotation to correct for scan artifacts. In exemplary embodiments, the method 200 can be implemented within reticule model based OPC calibration, and enhance model performance, based on improved data accuracy.

The contour biasing methods described herein can be implemented in any suitable computer system that can receive data from DBM systems and SEM tools, as well as store the design layout and sample contour plan. The suitable computing system can also generate the raw contour and optimized contour data as described herein.

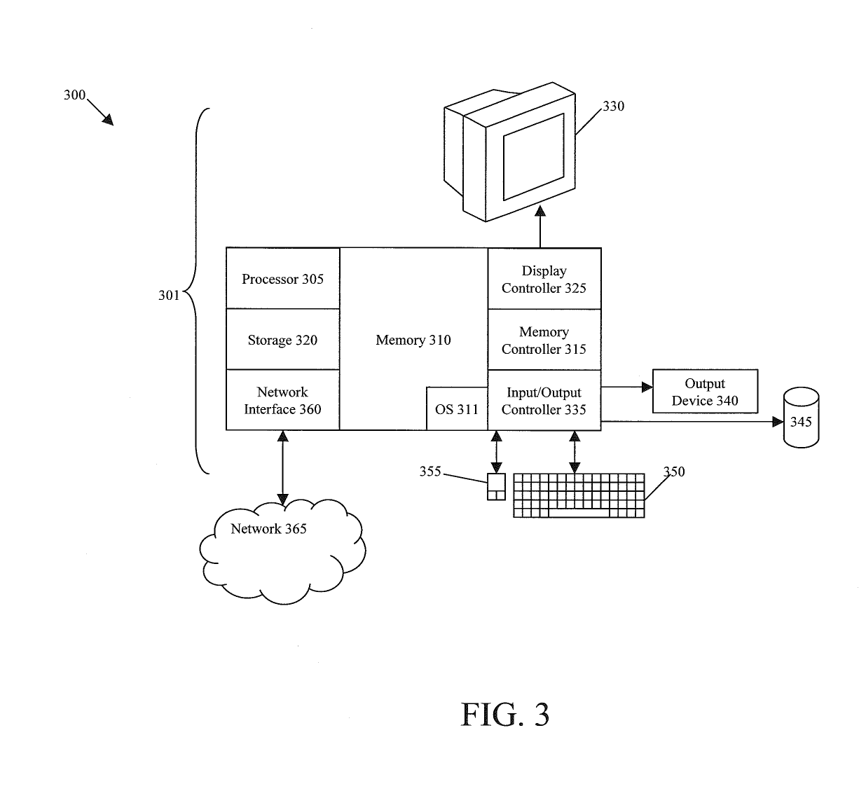

FIG. 3 illustrates an exemplary embodiment of a system 300 for contour biasing. The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 300 therefore includes general-purpose computer 301.

In exemplary embodiments, in terms of hardware architecture, as shown in FIG. 3, the computer 301 includes a processor 305, memory 310 coupled to a memory controller 315, and one or more input and/or output (I/O) devices 340, 345 (or peripherals) that are communicatively coupled via a local input/output controller 335. The input/output controller 335 can be, but is not limited to, one or more buses or other wired or wireless connections, as is known in the art. The input/output controller 335 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 305 is a hardware device for executing software, particularly that stored in memory 310. The processor 305 can be any custom made or commercially available processor, a central processing unit (CPU), an auxiliary processor among several processors associated with the computer 301, a semiconductor based microprocessor (in the form of a microchip or chip set), a macroprocessor, or generally any device for executing software instructions.

The memory 310 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 310 may incorporate electronic, magnetic, optical, and/or other types of storage media. Note that the memory 310 can have a distributed architecture, where various components are situated remote from one another, but can be accessed by the processor 305.

The software in memory 310 may include one or more separate programs, each of which comprises an ordered listing of executable instructions for implementing logical functions. In the example of FIG. 3, the software in the memory 310 includes the contour biasing methods described herein in accordance with exemplary embodiments and a suitable operating system (OS) 311. The OS 311 essentially controls the execution of other computer programs, such the contour biasing systems and methods as described herein, and provides scheduling, input-output control, file and data management, memory management, and communication control and related services.

The contour biasing methods described herein may be in the form of a source program, executable program (object code), script, or any other entity comprising a set of instructions to be performed. When a source program, then the program needs to be translated via a compiler, assembler, interpreter, or the like, which may or may not be included within the memory 310, so as to operate properly in connection with the OS 311. Furthermore, the contour biasing methods can be written as an object oriented programming language, which has classes of data and methods, or a procedure programming language, which has routines, subroutines, and/or functions.

In exemplary embodiments, a conventional keyboard 350 and mouse 355 can be coupled to the input/output controller 335. Other output devices such as the I/O devices 340, 345 may include input devices, for example but not limited to a printer, a scanner, microphone, and the like. The I/O devices 340, 345 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The I/O devices can further include SEM tools and DBM system components as described herein. The system 300 can further include a display controller 325 coupled to a display 330. In exemplary embodiments, the system 300 can further include a network interface 360 for coupling to a network 365. The network 365 can be an IP-based network for communication between the computer 301 and any external server, client and the like via a broadband connection. The network 365 transmits and receives data between the computer 301 and external systems. In exemplary embodiments, network 365 can be a managed IP network administered by a service provider. The network 365 may be implemented in a wireless fashion, e.g., using wireless protocols and technologies, such as WiFi, WiMax, etc. The network 365 can also be a packet-switched network such as a local area network, wide area network, metropolitan area network, Internet network, or other similar type of network environment. The network 365 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 301 is a PC, workstation, intelligent device or the like, the software in the memory 310 may further include a basic input output system (BIOS) (omitted for simplicity). The BIOS is a set of essential software routines that initialize and test hardware at startup, start the OS 311, and support the transfer of data among the hardware devices. The BIOS is stored in ROM so that the BIOS can be executed when the computer 301 is activated.

When the computer 301 is in operation, the processor 305 is configured to execute software stored within the memory 310, to communicate data to and from the memory 310, and to generally control operations of the computer 301 pursuant to the software. The contour biasing methods described herein and the OS 311, in whole or in part, but typically the latter, are read by the processor 305, perhaps buffered within the processor 305, and then executed.

When the systems and methods described herein are implemented in software, as is shown in FIG. 3, the methods can be stored on any computer readable medium, such as storage 320, for use by or in connection with any computer related system or method.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In exemplary embodiments, where the contour biasing methods are implemented in hardware, the contour biasing methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

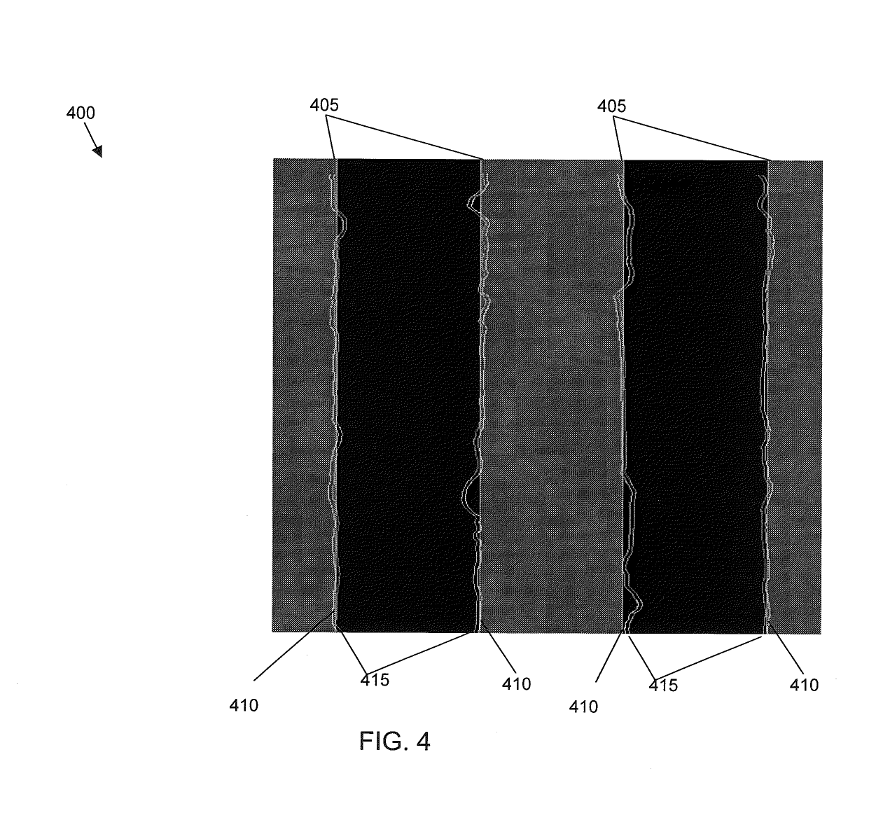

FIG. 4 illustrates example contours 400 in accordance with exemplary embodiments. In the example, original design 405 is illustrated. The actual measured contours 410 after fabrication are also shown, as measured by SEM for example. Modified contours 415 generated in accordance with exemplary embodiments are also shown. As explained previously, since this is 1D contour, the modified contours 415 are simply offset from original measured contours, which provides an improvement to match the physical contour (not shown) to be modeled.

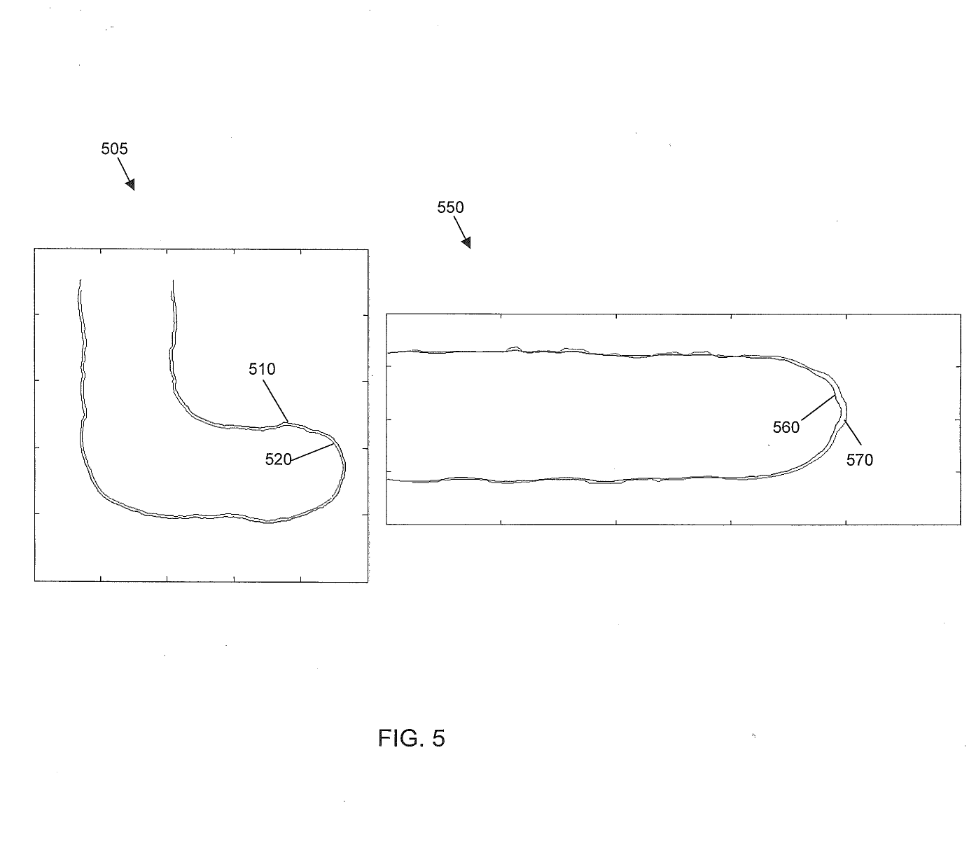

FIG. 5 illustrates contour examples 505, 550 correction for 2D example contours. In the examples 505, 550, first curves 510, 560 are the originally measured SEM contour (raw contours), while the second curves 520, 570 are the corrected/optimized contours to be used for modeling. The contour example 505 was applied a constant bias regardless of local radius, while on the contour example 550 was applied a varying bias as a function of curvature.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A contour biasing method, comprising:
receiving contour input files;
processing the contour input files;
receiving contour measurements;
receiving raw contour data;
processing the raw contour data; and
outputting processed contour data based on the contour input files.

2. The method as claimed in claim 1 wherein the contour input files include a photomask design layout.

3. The method as claimed in claim 2 wherein the contour input files include a contour sample plan to which the raw contour data is to be fit.

4. The method as claimed in claim 3 wherein the contour input files include a computer aided design (CAD) recipe.

5. The method as claimed in claim 1 wherein the raw contour data is scanning electron microscopy data of an actual processed layout.

6. The method as claimed in claim 1 wherein processing the raw contour data includes correcting scanning electron microscopy (SEM) magnification.

7. The method as claimed in claim 1 wherein processing the raw contour data includes correcting scanning electron microscopy (SEM) contour-physical bias, a bias between SEM data and physical data.

8. The method as claimed in claim 1 wherein processing the raw contour data can include at least one of contour vector shifting, global scaling to correct for SEM magnification; and rotating the raw contour data to correct for scan artifacts.

9. A computer program product including a non-transitory computer readable medium having instructions for causing a computer to implement a contour biasing method, comprising:
receiving contour input files;
processing the contour input files;
receiving contour measurements;
receiving raw contour data;
processing the raw contour data; and
outputting processed contour data based on the contour input files.

10. The computer program product as claimed in claim 9 wherein the contour input files include a photomask design layout.

11. The computer program product as claimed in claim 10 wherein the contour input files include a contour sample plan to which the raw contour data is to be fit.

12. The computer program product as claimed in claim 11 wherein the contour input files include a computer aided design (CAD) recipe.

13. The computer program product as claimed in claim 9 wherein the raw contour data is scanning electron microscopy data of an actual processed layout.

14. The computer program product as claimed in claim 9 wherein processing the raw contour data includes correcting scanning electron microscopy (SEM) magnification.

15. The computer program product as claimed in claim 9 wherein processing the raw contour data includes correcting scanning electron microscopy (SEM) contour-physical bias, a bias between SEM data and physical data.

16. The computer program product as claimed in claim 9 wherein processing the raw contour data can include at least one of contour vector shifting, global scaling to correct for SEM magnification; and rotating the raw contour data to correct for scan artifacts.

17. A contour biasing system, comprising:
a processor configured to:
receive contour input files for a design based metrology (DBM) system;
process the contour input files;
receive contour measurements;
receive raw contour data from a scanning electron microscopy (SEM) system;
process the raw contour data; and
output processed contour data based on the contour input files.

18. The system as claimed in claim 17 wherein the contour input files include at least one of a photomask design layout, a contour sample plan to which the raw contour data is to be fit and a computer aided design (CAD) recipe.

19. The system as claimed in claim 17 wherein processing the raw contour data includes at least one of correcting scanning electron microscopy (SEM) magnification, and correcting SEM contour-physical bias, a bias between SEM data and physical data.

20. The system as claimed in claim 17 wherein processing the raw contour data can include at least one of contour vector shifting, global scaling to correct for SEM magnification; and rotating the raw contour data to correct for scan artifacts.
